(19) United States
(12) Patent Application Publication
(10) Pub. No.: US 2010/0293097 A1
(43) Pub. Date: Nov. 18, 2010

(54) PEER-TO-PEER FILE SHARING SYSTEM WITH DATA ACCOUNTING

(76) Inventor: Jordan POMEROY, The Woodlands, TX (US)

Correspondence Address: BACON & THOMAS, PLLC, 625 SLATERS LANE, FOURTH FLOOR, ALEXANDRIA, VA, 22314-1176, US

(21) Appl. No.: 12/779,395

(22) Filed: May 13, 2010

Related U.S. Application Data
(60) Provisional application No. 61/178,236, filed on May 14, 2009.

(51) Int. Cl. H04L 9/00; G06Q 30/00; G06Q 20/00; G06Q 50/00; G06Q 10/00; G06F 15/16

(52) U.S. Cl. 705/58; 713/150; 709/204

(57) ABSTRACT

A file sharing system includes a first primary peer which shares data with other peers via a tracker. The tracker divides the data into blocks and encrypts each block of the first data with a key that is unique to the first primary peer and the respective block of data. As the encrypted blocks of data are passed from peer to peer in the file sharing system, the tracker is always able to identify the primary which provided the data. Additionally, primary peers are compensated in accordance with the number of downloads of their respective data.

This application claims the benefit of U.S. Provisional Application No. 61/178,236, filed May 14, 2009, which is incorporated here in its entirety.

### FIELD OF THE INVENTION

The present invention relates to a peer-to-peer file sharing system. Specifically, the present invention relates to a method and apparatus for data accounting in the file sharing system.

### BACKGROUND

Peer-to-peer file sharing systems are designed to widely distribute large amounts of data, while minimizing costly server and bandwidth resources. in known file sharing systems, when multiple users download the same file at the same time, the various users upload pieces of the file to each other. In other words, a user trades pieces of a file for other required pieces that other users have until the complete file is obtained.

Known file sharing systems, however, do not ensure that each user is supplying accurate usage statistics, since the source of the data cannot be trusted. Furthermore, to accomplish a successful download, at least one user involved in the download must have a complete copy of the file. Therefore, a file sharing system which incentivizes users to host data and which verifies the accuracy of the usage statistics is needed.

Accordingly, exemplary embodiments of the file sharing system are described herein which solve the aforementioned problems.

### SUMMARY

In accordance with an embodiment of the invention, a file sharing system includes content providers, primary peers, leechers, and a tracker. Content providers are computing devices which provide digital data to the tracker. The primary peers and leechers are computing devices connected to a network. The tracker is a computing device which includes a web server.

A first primary peer is connected to the tracker over the network. The tracker receives first data from at least one of a content provider and the first primary peer. The first primary peer makes arrangements with the tracker to host the first data. The tracker divides the first data into blocks and encrypts each block of the first data with a key that is unique to the first primary peer and the respective block of data.

A first leecher is connected to the first primary peer over the network and receives at least one encrypted block of the first data from the first primary peer. A second leecher is connected to the first leecher over the network and receives the at least one encrypted block from the first leecher. Further, in response to requests from the first leecher and the second leecher, the tracker sends the key to the first leecher and the second leecher. The first primary peer may be compensated for each request for the key.

Additional content providers, primary peers and leechers may be connected to the network. The invention may also include multiple networks.

Additionally, in accordance with an embodiment of the invention, a method in a peer-to-peer file sharing network for data accounting includes receiving data from at least one of a content provider and first primary peer, further dividing the data into blocks, and encrypting each block of the data with a key that is unique to the first primary peer and the respective block of data. At least one encrypted block of the data is received from the tracker. The at least one encrypted block is further sent to a first leecher.

In response to a request to the tracker, the key is sent to the first leecher. The at least one encrypted block is also sent from the first leecher to a second leecher and in response to a request to the tracker, the key is sent to the second leecher. The first primary peer may be compensated for each request for the key.

The method may include additional content providers, primary peers and leechers. The method may also include multiple networks.

Further, in accordance with embodiments of the invention, by encrypting the data blocks such that they uniquely identify the registering primary peer, the file sharing system is able to track the passage of data between generations. As such, the tracker can identify the primary peer of any data block in the file sharing system even after the data block has passed from the primary peer to a leecher and on to another leecher.

To ensure that each peer of the file sharing system is supplying accurate data, the tracker can compare the hash value of each block of the encrypted data, which is stored at the tracker, with calculated hash values sent to the tracker by the first and second leechers. The tracker can indicate to the first and second leechers whether the calculated hash values are valid.

### BRIEF DESCRIPTION OF THE DRAWINGS

Features, aspects, and advantages of the present invention will become better understood with regard to the following description, appended claims, and accompanying drawings.

FIG. 1 is a block diagram illustrating the framework of the file sharing system according to an embodiment of the invention.

FIG. 2 is a block diagram illustrating a process of registering data with the tracker according to an embodiment of the invention.

FIG. 3 is a block diagram illustrating a process of sharing data between peers according to an embodiment of the invention.

FIG. 4 is a block diagram illustrating a process of sharing data between peers according to an embodiment of the invention.

FIG. 5 is a block diagram illustrating a process of distributing decryption keys to leechers and compensating primary peers according to an embodiment of the invention.

FIG. 6 illustrates a process of registering data with the tracker according to an embodiment of the invention.

FIG. 7 illustrates a process of sharing files between peers.

### DETAILED DESCRIPTION OF VARIOUS EMBODIMENTS

A. Overview

A better understanding of different embodiments of the invention may be had from the following description read in conjunction with the accompanying drawings in which like reference characters refer to like elements.

While the disclosure is susceptible to various modifications and alternative constructions, certain illustrative embodiments are shown in the drawings and are described below in detail. It should be understood, however, that there is no intention to limit the disclosure to the specific embodiments disclosed, but on the contrary, the intention is to cover all modifications, alternative constructions, combinations, and equivalents falling within the spirit and scope of the disclosure.

It will be understood that, unless a term is expressly defined in this patent to possess a described meaning, there is no intent to limit the meaning of such term, either expressly or indirectly, beyond its plain or ordinary meaning.

Any element in a claim that does not explicitly state “means for” performing a specified function, or “step for” performing a specific function, is not to be interpreted as a “means” or “step” clause as specified in 35 U.S.C. § 112, paragraph 6.

B. General Framework of the File Sharing System

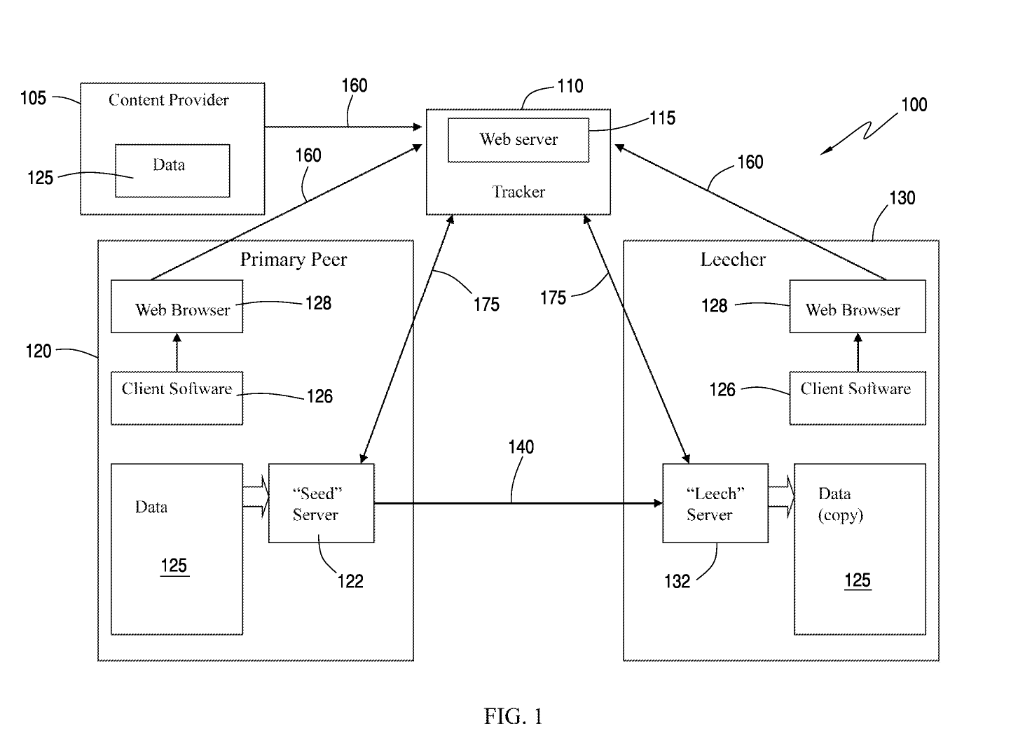

FIG. 1 is a schematic block diagram illustrating the general framework of the file sharing system 100. As shown in FIG. 1, a primary peer 120, desiring to send data 125 to a leecher 130, interacts with a tracker 110 that is part of the file sharing system 100 over a network. The tracker is a computing device, such as a computer, which includes a web server 115. The general framework of the file sharing system 100 is similar to a Bit Torrent file sharing system in that peers desiring to share a file interact with a tracker to facilitate the file sharing process. Additionally, the downloading process of the file sharing system 100 takes place in a swarm delivery manner in accordance with the Bit Torrent file sharing system. For a more detailed discussion of the BitTorrent file distribution system, see, for example, the BitTorrent specification, http://bittorrent.org/beps/bep_{—}000,html (downloaded Mar. 30, 2009), and incorporated by reference herein.

Generally, to publish data 125 using the file sharing system 100, a content provider computing device 105 sends the data 125 to the tracker 110. Alternatively, the primary peer 120 may send the data 125 to the tracker 110. In particular, as shown in FIG. 1, the content provider computing device 105 or the primary peer computing device 120 typically initiates a network connection to send the data 125 to the tracker 110. The client software 126 is a program running on the computing devices of the primary peer and the leecher that manages the uploads and downloads. The web browser 128 communicates with the web server 115 of the tracker, for example, by means of conventional HTTP communications 160.

To upload the data 125 during a download process, a primary peer 120 initiates a seed server 122, using the client software 126. The tracker 110 helps the leecher 130 find the primary peer 120 and other leechers during a downloading process. Each user 120,130 reports to all of its peers via the tracker 110, the availability of data held by the respective user 120, 130. Generally, each peer sends tracker messages 175 to the tracker 110. Additionally, each user communicates data availability to all other users in a swarm.

On the leecher side 130, in response to a request, the tracker 110 returns a list of primary peers to the leecher. The leecher may request a list of all primary peers to a particular file. Alternatively, the leecher may request a list of all available data. After the leecher selects the desired data to download, the client software 126 is launched on the leecher 130 and the client software initiates a “leech” server 132 that allows the leecher 130 to connect to the tracker 110. In this manner, the data 125 is sent from the “seed server” 122 to the “leech server” 132 via connection 140, such as a peer-to-peer connection or swarm delivery.

C. Various Embodiments of the File Sharing System

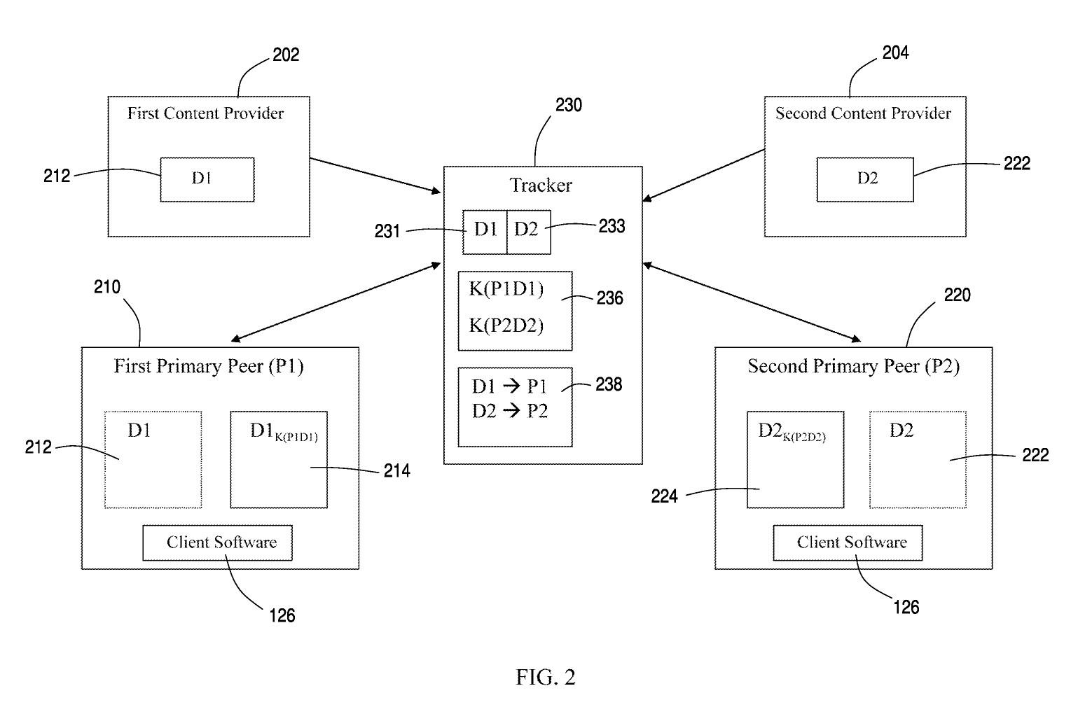

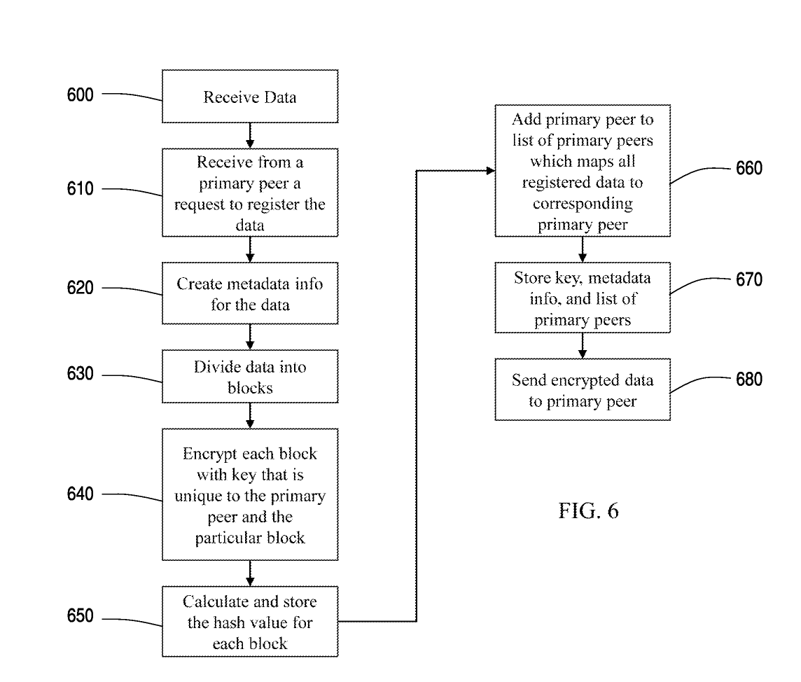

FIGS. 2 and 6 illustrate a process of registering data with the tracker 230 according to the file sharing system 100 of the disclosure. Users of the file sharing system 100 connect to the network via computing devices, such as computers. Users of the file sharing system that provide data to the tracker will be referred to as “content providers.” The term “content provider,” as used herein, is defined as the computing device by which the user connects to the tracker. Users of the file sharing system that register data with the tracker 230 will be referred to as primary peers. The term “primary peer” is defined as the computing device by which the user connects to the network. Likewise, the term “leecher” is defined as the computing device by which the particular user connects to the network.

In step 600, the tracker 230 receives original data content 212 from a first content provider 202. Alternatively, the tracker may receive the original data content 212 from a first primary peer 210. In step 610, the first primary peer 210 arranges to host the original data content 212 by sending a request to register the original data content to the tracker 230. The original data content 212 can be one or more files or even a portion of a file.

In step 620, the tracker 230 creates and stores metadata info 231,233 for the original data content 212,222. The metadata info contains information about the original data content 212,222, including its length, name, encryption data, and hashing information. The metadata may be stored in a file, or alternatively in a database. Step 620 may occur at a different point in the registration process than illustrated in FIG. 6.

Next, in step 630, the tracker 230 breaks the original data content 212 into blocks, preferably of equal size. The tracker 230 then, in step 640, encrypts each data block with a key that is unique to the first primary peer 210 and the respective data block. The original data content 212 is encrypted by a stream cipher encryption technique. However, other encryption techniques may be employed as long as the encryption key uniquely identifies the respective primary peer and the respective data block. The encryption key K(P1D1) uniquely identifies the first primary peer and the encrypted data block 214. The tracker then uses a hash function to calculate the hash value of each encrypted data block 214, in step 650. The hash value of the encrypted data block 214 may also identify the first primary peer 210 and the key K(P1D1).

In step 680, the tracker 230 sends each encrypted data block 214 to the first primary peer 210. The first primary peer 210 may periodically send the tracker a message announcing that the first primary peer 210 is available to upload the encrypted data block 214 to other peers. However, other suitable peer discovery methods may be used.

FIG. 2 also illustrates the registration process of a second primary peer 220. The process of arranging to host data with the tracker for the second primary peer 220 is the same as the process for the first primary peer 210. Particularly, the second primary peer 220 sends a request to register the original data content 222 to the tracker 230. In step 680, the tracker 230 sends each encrypted data block 224 to the second primary peer 220. As previously described with reference to the first primary peer 210, the encryption key K(P2D2) for the second primary peer 220 uniquely identifies the second primary peer 220 and the encrypted data block 224. The tracker may receive the original data content 222 from a second content provider 204, or alternatively, the tracker may receive the original data content 222 from the second primary peer 220.

The tracker also stores the key for each encrypted data block in a list of keys 236, and further, in steps 660,670, creates and stores a list of all registered data which indicates the primary peer that has the respective data. In alternate embodiments, steps 650-680 may occur in any order.

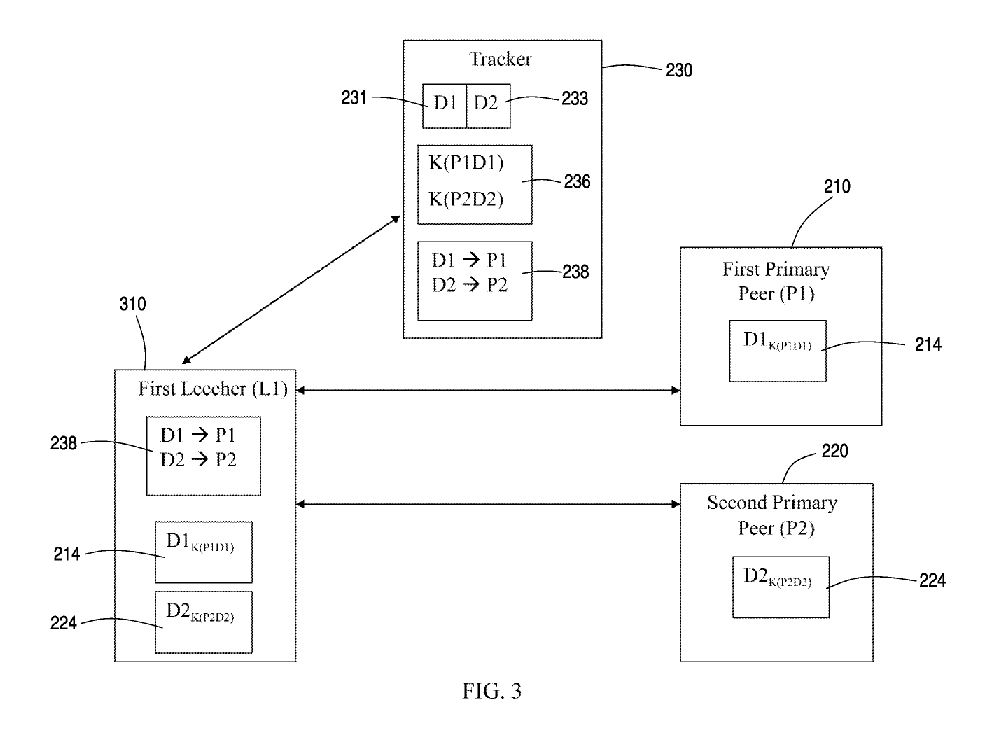

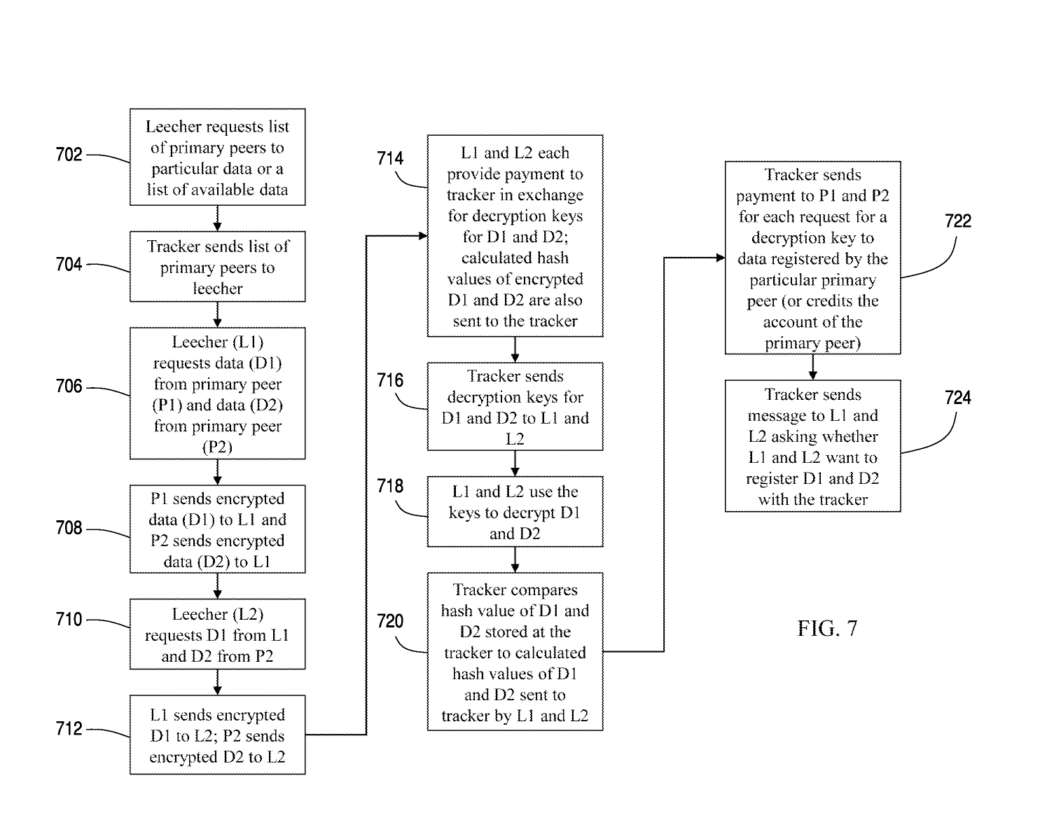

FIGS. 3 and 7 illustrate a process of sharing data between peers in the file sharing system 100. In step 702, a first leecher 310 requests from the tracker 230 a list of primary peers to a particular data content, or alternatively requests a list of all available data. Other suitable methods of obtaining a list of primary peers from the tracker may also be used. The tracker responds, in step 704, by sending a list of primary peers to the leecher. As shown in FIG. 3, the list of primary peers 238 sent to the first leecher 310 is the complete list stored with the tracker. However, any relevant portion of the list of primary peers 238 stored with the tracker 230 may be sent to the first leecher 310 in accordance with the particular request from the first leecher 310.

In step 706, the first leecher 310 then requests the encrypted data block 214 from the first primary peer 210 and the encrypted data block 224 from the second primary peer 220. In response, the first primary peer 210 sends the encrypted data block 214 to the first leecher 310 and the second primary peer 220 sends the encrypted data block 224 to the first leecher 310, in step 708.

The metadata info 231,233 and/or at least the hash of the encrypted data blocks 214,224 may be passed along through the file sharing system with their corresponding encrypted data block 214,224. In other words, the metadata info 231,233 and/or at least the hash of the encrypted data blocks 214,224 may be passed from the tracker 230 to the first and second primary peers 210,220, and further to the first leecher 310 along with the encrypted data blocks 214,224.

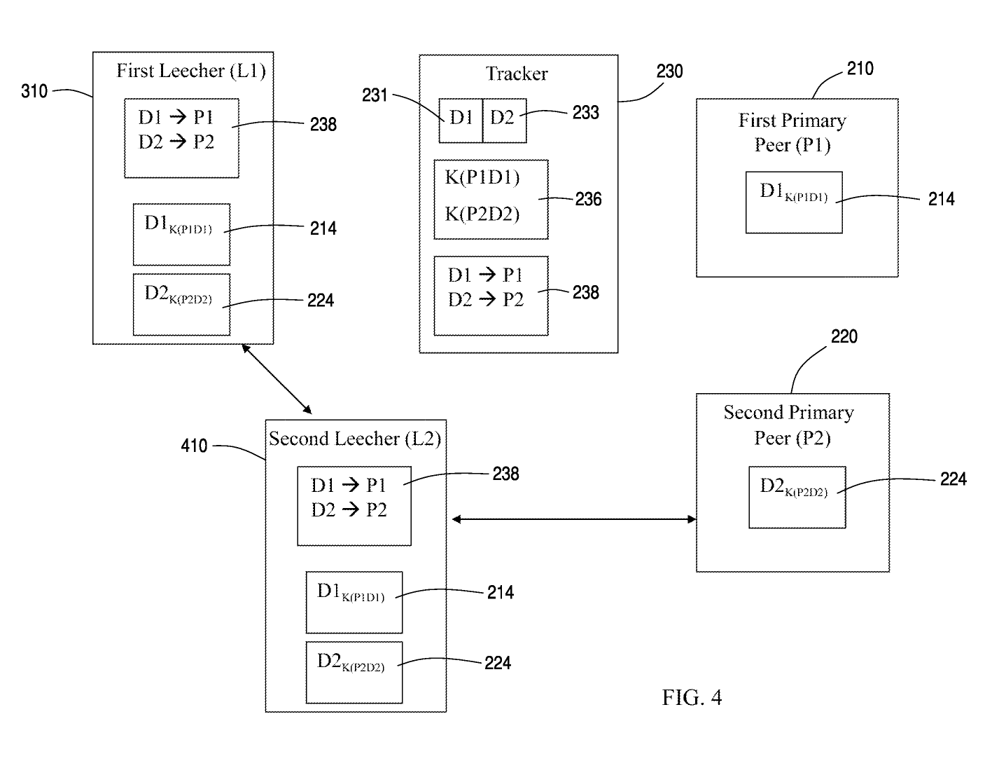

Turning to FIG. 4, which illustrates a swarm delivery, a second leecher 410 requests encrypted data block 214 from the first leecher 310 and the encrypted data block 224 from the second primary peer 220, in step 710. In response to the request from the second leecher 410, in step 712, the first leecher 310 sends encrypted data block 214 to the second leecher 410 and the second primary peer 220 sends encrypted data block 224 to the second leecher 410. The second leecher 410 may be provided with the list of primary peers 238 to facilitate the file sharing process.

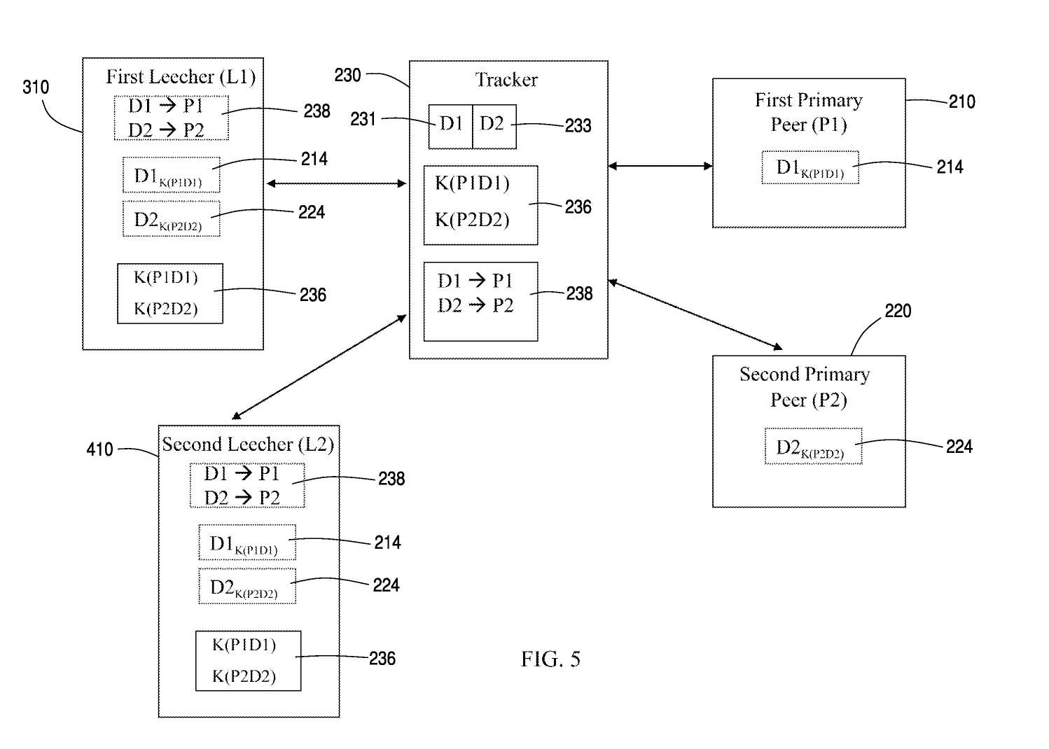

In order to decrypt their downloaded encrypted data, downloading peers must receive an encryption key from the tracker 230 for their particular downloaded content. The file sharing system 100 may require downloading peers to pay for the encryption keys. In reference to FIG. 5, the first leecher 310 pays the tracker 230 for the encryption keys to the encrypted data block 214 and the encrypted data block 224. The second leecher 410 also pays the tracker 230 for the encryption keys to the encrypted data block 214 and the encrypted data block 224, as illustrated in step 714. In addition to the payments, the first and second leechers 310, 410 also calculate and send a hash of the encrypted data blocks 214, 224 to the tracker. The hash enables the tracker 230 to provide the appropriate key. In response to the requests from the first leecher 310 and the second leecher 410, in step 716, the tracker sends the encryption keys K(P1D1) and K(P2D2) to the first and second leechers 310,410.

To ensure data integrity, in step 720, the tracker 230 compares the hash value of the encrypted data blocks 214,224 stored at the tracker with the calculated hash values sent to the tracker by the first and second leechers 310,410. The tracker will indicate to the first and second leechers 310,410 whether the calculated hash values are valid.

The integrity check ensures that each peer of the file sharing system 100 is supplying accurate data. By encrypting the data blocks 214,224 such that they uniquely identify the registering primary peer, the file sharing system 100 is able to track the passage of data between generations. In other words, even after the encrypted data blocks 214,224 have passed from a registered primary peer to a leecher and on to another leecher, the file sharing system will be able to identify the primary peer that registered the data blocks. Particularly, the tracker 230 can identify the primary peer of any data block in the file sharing system. As such, when a leecher contacts the tracker for a decryption key, the tracker is able to identify the appropriate key.

In response to payment by the first and second leechers 310,410, the tracker sends a payment to the first and second primary peers 210,220 for each request for a key to data registered by the first and second primary peers 210,220, in step 722. Alternatively, the tracker may send payment to the first and second primary peers only upon confirmation from the integrity check that the data blocks 214,224 are accurate. In another embodiment, the payment to the first and second primary peers 210,220 may be sent directly from the first and second leechers 310,410.

Additionally, the first and second content providers 202,204 may be compensated for each request for a key to data supplied to the tracker 230 by the particular content provider.

Compensating primary peers for each request for a key to data registered by a particular primary peer creates an incentive to register with the tracker 230 and offer data to be uploaded in the file sharing system 100.

In another embodiment, users of the file sharing system 100 may create an account with the tracker 230. Users can add money to the account such that instead of the first and second leechers 310,410 sending a payment to the tracker 230, the tracker may simply deduct the payment amount from the accounts of the first and second leechers. Likewise, instead of sending a payment to the first and second primary peers 210,220, the tracker 230 may credit the accounts of the first and second primary peers.

After downloading the encrypted data blocks 214,224, the first and second leechers 310,410 may register their respective data blocks 214,224 with the tracker in order to become primary peers. To facilitate the registration process for the first and second leechers, the tracker 230 may send a message to the first and second leechers asking whether they wish to register their respective data blocks with the tracker, as illustrated in step 724. Alternatively, the leechers 310,410 may configure their accounts with the tracker 230 such that they automatically become primary peers.

Additionally, to promote file sharing, the client software 126 may be configured to adjust a user's download bandwidth in accordance with the user's selected upload bandwidth. In other words, as users increase their upload bandwidth, they will be provided with more download bandwidth.

While the foregoing embodiments have been described and shown, it is understood that alternatives and modifications of these embodiments, such as those suggested by others, may be made to fall within the scope of the invention.

1. A file sharing system, comprising:
a first primary peer connected to a network;
a tracker connected to the first primary peer over the network, the tracker receiving first data, wherein the tracker divides the first data into blocks and encrypts each block of the first data with a key that is unique to the first primary peer and the respective block of data;
a first leecher connected to the first primary peer over the network, wherein the first leecher receives at least one encrypted block of the first data from the first primary peer;
a second leecher connected to the first leecher over the network, wherein the second leecher receives the at least one encrypted block from the first leecher,
wherein, in response to requests from the first leecher and the second leecher, the tracker sends the key to the first leecher and the second leecher.

2. The file sharing system of claim 1, wherein the first primary peer is compensated for each request for the key.

3. The file sharing system of claim 1, wherein the tracker stores a hash value of the at least one encrypted block, the first and second leechers calculate respective hash values of the at least one encrypted block, and the stored hash value is compared to the respective calculated hash values.

4. The file sharing system of claim 1, wherein first leecher and the second leecher provide a payment to the tracker in exchange for the key.

5. The file sharing system of claim 1, wherein the first primary peer, the first leecher, and the second leecher have an account with the tracker, the account of the first primary peer is credited for each request for the key, and a payment amount is deducted from the accounts of the first and second leechers in exchange for the key.

6. The file sharing system of claim 1, wherein after the first leecher receives the at least one encrypted block from the first primary peer, the tracker encrypts the at least one encrypted block with a key that is unique to the first leecher and the respective block of the at least one encrypted block.

7. The file sharing system of claim 1, wherein the tracker receives the first data from at least one of a content provider and the first primary peer.

8. A method in a peer-to-peer file sharing network for data accounting, comprising:
receiving data at a tracker computing device;
connecting the tracker computing device to a first primary peer computing device over a network;
dividing the data into blocks with the tracker computing device, and encrypting each block of the data with a key that is unique to the first primary peer and the respective block of data;
receiving at least one encrypted block of the data from the tracker computing device;
sending the at least one encrypted block to a first leecher computing device;
in response to a request to the tracker computing device, sending the key to the first leecher computing device;
sending the at least one encrypted block from the first leecher computing device to a second leecher computing device; and
in response to a request to the tracker computing device, sending the key to the second leecher computing device;

9. The method for data accounting in claim 8, further comprising:
compensating the first primary peer computing device for each request for the key.

10. The method for data accounting in claim 8, further comprising:
storing a hash value of the at least one encrypted block with the tracker computing device;
calculating respective hash values of the at least one encrypted block with the first and second leecher computing devices; and
comparing the stored hash value with the respective calculated hash values.

11. The method for data accounting in claim 8, further comprising:
providing a payment from the first leecher computing device and a payment from the second leecher computing device to the tracker computing device in exchange for the key.

12. The method for data accounting in claim 8, wherein the first primary peer computing device, the first leecher computing device, and the second leecher computing device have an account with the tracker computing device, the account of the first primary peer computing device is credited for each request for the key, and a payment amount is deducted from the accounts of the first and second leecher computing devices in exchange for the key.

13. The method for data accounting in claim 8, wherein after the first leecher computing device receives the at least one encrypted block from the first primary peer, the tracker computing device encrypts the at least one encrypted block with a key that is unique to the first leecher computing device and the respective block of the at least one encrypted block.

14. The method for data accounting in claim 8, wherein the tracker computing device receives the first data from at least one of a content provider and the first primary peer.

15. A method in a peer-to-peer file sharing network for data accounting, comprising:
receiving first data from a first primary peer computing device;
dividing the first data into blocks with a tracker computing device, and encrypting each block of the first data with a first key that is unique to the first primary peer and the respective block of first data;
receiving second data from a second primary peer computing device;
dividing the second data into blocks with the tracker computing device, and encrypting each block of the second data with a second key that is unique to the second primary peer and the respective block of second data;
receiving at least one encrypted block of the first data from the tracker computing device;
sending the at least one encrypted block of first data to a first leecher computing device;
receiving at least one encrypted block of the second data from the tracker computing device;
sending the at least one encrypted block of second data to the first leecher computing device;
in response to a request to the tracker computing device, sending the first and second keys to the first leecher computing device;
sending the at least one encrypted block of first data from the first leecher computing device to a second leecher computing device;
sending the at least one encrypted block of second data from the second primary peer computing device to the second leecher computing device; and
in response to a request to the tracker computing device, sending the first and second keys to the second leecher computing device.
